(19) United States
(12) Patent Application Publication
(10) Pub. No.: US 2007/0199752 A1
(43) Pub. Date: Aug. 30, 2007

(54) Controlled Air-Conditioning Device And Method For Controlling Said Air-Conditioning

(76) Inventor: Giovanni Nieddu, Merignac (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/571,420

(22) PCT Filed: Sep. 7, 2004
(86) PCT No.: PCT/FR04/50414

§ 371 Date: Nov. 6, 2006

(30) Foreign Application Priority Data
Sep. 12, 2003 (FR) 0310740

(51) Int. Cl. B60K 11/04

(52) U.S. Cl. 180/68.6

(57) ABSTRACT

The invention relates to a controlled air-conditioning device for a vehicle comprising a compressor (2) which is driven by the vehicle engine (1) through a clutch unit (3), a condenser (7), at least one evaporator (8, 9) and a main circuit for coolant fluid flowing between the compressor (2), condenser (7) and the evaporator (8, 9). Said main circuit comprises a first line (30) for supplying fluid from the compressor (2) to the condenser (7), a second line (31) for supplying fluid from the condenser (7) to the evaporator (8, 9), a third line (32) which sucks fluid from the evaporator (8, 9) towards the compressor (2) and is provided with an additional circuit (33) disposed between the first line (30) and the third line (32) which returns gases exhausted by the compressor directly towards the suction thereof and comprises a control device (5, 10) for switching on and off the additional circuit.

The present invention relates to a vehicle air conditioning pilot device and its use.

Air conditioning devices and methods driven by a computer or automatic control unit exist and are generally based on a temperature sensor on the interior of the vehicle, a motor-driven compressor, a condenser with one or more evaporators downwind of it, designed to produce cooled air for the vehicle's passenger compartment, a computer monitoring the interior temperature of the vehicle causing the position of an air inlet valve to alternate between external air and cooled air in order to regulate the temperature of the passenger compartment.

Traditional systems are designed to provide their best output for a vehicle's motor rotation speed driving the main compressor and a coupling of the compressor with the motor during long periods without frequent uncoupling. These systems are optimized for an operating speed within the optimal working range of the vehicle's engine, while their efficiency is poor for motor speeds near idling.

In the case of city transportation vehicles, the vehicle motor spends a majority of the time idling, with frequent periods of acceleration and deceleration and few extended periods of running at an elevated motor speed.

The device and method defined by this invention are intended to create a piloted air conditioning device adapted to optimal performance when the vehicle is idling, without degrading the vehicle acceleration or energy efficiency.

To accomplish this, the air conditioning pilot device, within this invention, comprising a compressor powered by the vehicle's motor by way of clutch engagement, a condenser, at least one evaporator and circuit, or main circuit, for circulating refrigerant fluid between the compressor, the condenser, and the said evaporator, comprising a first branch circuit leading fluid from the compressor to the condenser, a second branch circuit leading fluid from the condenser to the evaporator, a third branch circuit pulling fluid from the evaporator toward the compressor, characterized by having a complementary circuit, located between the first branch circuit and the third branch circuit of the main circuit, designed to return gas collected by the compressor to the air intake of the compressor and a control device for enabling and disabling the complementary circuit. The device is advantageous, notably for city transport vehicles or for weak-engine vehicles that frequently travel within the city.

Advantageously, the main circuit can incorporate a check valve located on the first branch circuit downwind of the complementary circuit to hold fluid in the condenser when the complementary circuit is enabled.

In the preferred embodiment of the invention, the device incorporates a computer to manage the air conditioning device by detecting when the vehicle accelerates.

Advantageously, the computer can also incorporate a means by which to detect the motor speed while idling.

The invention also relates to a method for controlling an air conditioning pilot device, comprising of a compressor powered by the vehicle's motor by way of clutch engagement, a condenser, at least one evaporator and main circuit for circulating refrigerant fluid between the compressor, the condenser, and the said evaporator, designed to seal off the compressor and to isolate the main circuit, a control device for enabling the disabling the complementary circuit, a control device for engaging and disengaging the compressor, a means for detecting idling, acceleration, and deceleration of the vehicle, the method comprising sequences to enable the complementary circuit upon detection of acceleration or high motor speed in the vehicle. The method is advantageous in that it limits the number of actions engaging the compressor, allowing the air conditioning to be effective for city travel and very favorable, notably for city transport vehicles.

Most particularly, the method can comprise sequences to engage the complementary circuit simultaneously with the engagement of the compressor.

In the preferred embodiment of the invention, the method consists of sequences for engaging the compressor upon detection of acceleration or high motor speed in the vehicle.

According to one particular embodiment, the method involves sequences for temperature regulation of the vehicle's interior by managing the complementary circuit by means of measuring the temperature on the inside and outside of the vehicle.

In the most advantageous embodiment, the sequences enabling the complementary circuit for the detection of acceleration of the vehicle's motor are followed by maintenance sequences at work on the complementary circuit for a maximum duration of time as determined by a measure of the interior vehicle temperature.

Other characteristics and advantages of the invention are better understood by reading the description that follows an example of a non-limiting embodiment of the invention as referenced in the figures shown:

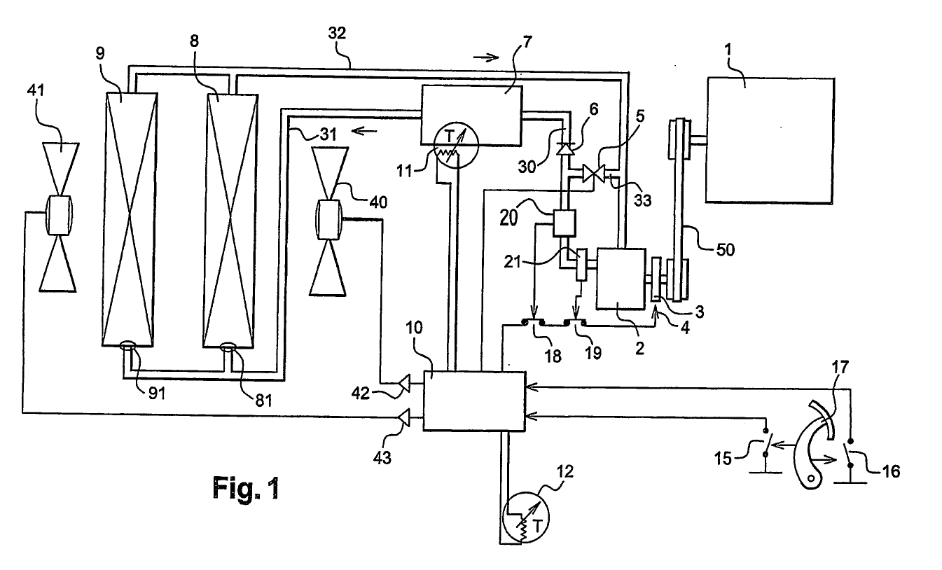

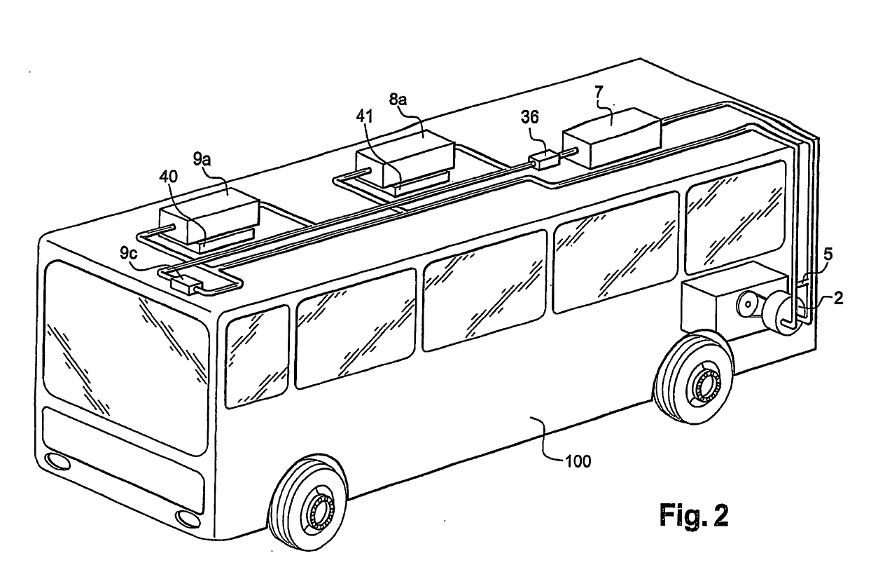

FIG. 1 is a schematic view of an air conditioning pilot device as defined by the invention;

FIG. 2 is a schematic view of a transport vehicle equipped with air conditioning devices as defined by the invention;

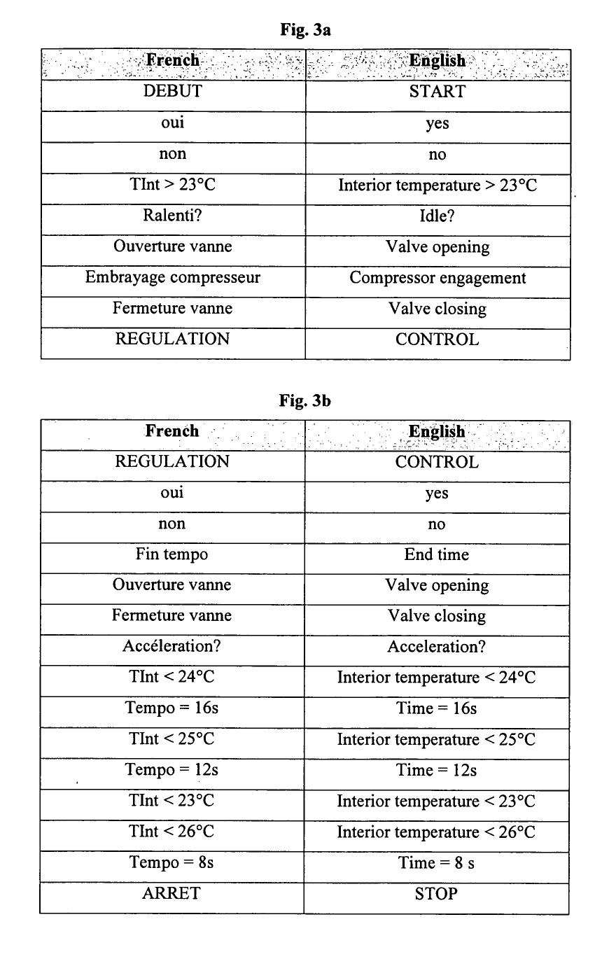

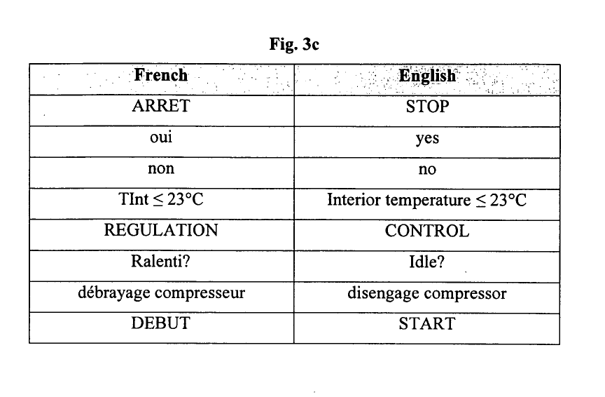

FIGS. 3a, 3b, and 3c illustrate the stages of operation of the device as defined by the method of the invention;

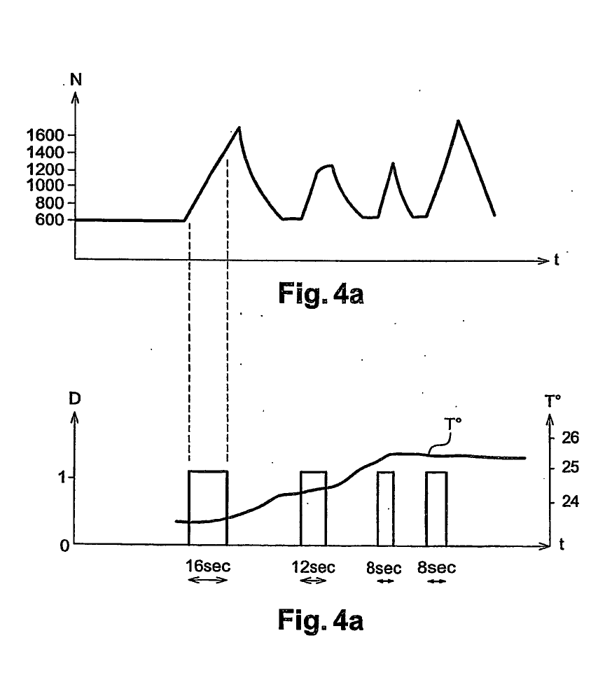

FIG. 4a illustrates an operation cycle for a common city transport vehicle.

FIG. 4b illustrates an operation cycle of the device as defined by the invention.

The air conditioning pilot device, notably for vehicle 100 as defined by the invention, is shown in FIG. 1 within the framework of its application on a common transport vehicle. It contains a compressor 2 powered by the vehicle's motor 1 by way of a clutch engagement 3. Powering the compressor is traditionally done using a belt 50, the means of engagement incorporating an electromagnetic signal 4 allowing the compressor to engage and disengage.

The device also contains a condenser 7 in which the refrigerant fluid passes from a gas to a liquid, two evaporators 8, 9 in the example, and a refrigerant circulating circuit between the compressor 2, the condenser 7, and the evaporators 8, 9. The evaporators are fit with valves 81, 91 allowing fluid to pass from a liquid to a cooled gas.

The circuit traditionally comprises a first branch circuit 30 leading fluid from the compressor 2 to the condenser 7, a second branch circuit 31 leading liquefied fluid from the condenser 7 to the evaporator, or in the example, to the evaporators 8, 9, a third branch circuit 32 for air intake allowing fluid to return from the evaporators 8, 9 to the compressor 2.

To optimize the air conditioning, a first item to take into account is that, in typical city use, the amount of time a vehicle spends running idle is very significant (around 30 to 50% of the time). The amount of time the vehicle's motor is running at top speed is limited to around 5% in a large city, and the remainder of the time includes moments of acceleration and deceleration.

To support an idling motor, it is advantageous to engage the compressor at a speed two or three times that of the motor. This means having good power from the compressor when the vehicle's motor is idling, contrary to a traditional air conditioning device that is optimized for vehicle cruising speeds at which the ratio of speed between the compressor and the motor is less than, for example, 2000 rpm in the compressor per 1600 rpm in the motor.

However, by the fact that the ratio between the compressor's rpm and the motor's rpm in a city use setting, a control based on the engagement and disengagement of the compressor without taking into account the vehicle's motor speed with frequent engagement of the compressor during vehicle acceleration, thereby limiting the available power for the accelerations, and with engagements of the compressor outside of moments of acceleration, which exercises significant constraints on the belt and the device engaging of the compressor, potentially causing these parts to wear out prematurely.

Also, for optimization of and adherence to a main aspect of the invention, the device allows for a complementary circuit 33, located between the first branch circuit 30 and the third branch circuit 32 of the main circuit, the complementary circuit being designed to seal off the compressor and return its retained gas to the air intake of the compressor. The operation of this complementary circuit seals off the compressor and frees up in motor 1 the power consumed by the air conditioning device without having to disengage the compressor.

In order to manage this complementary circuit 33, the invention allows for a device 5, 10 comprising a solenoid valve 5 and a controlling computer 10 for enabling and disabling the complementary circuit returning gas expelled by the compressor directly to the entrance to the compressor.

The solenoid valve would be able to be controlled directly through a button switch system on a position sensor on the accelerator, and its management by computer allows for optimal performance.

Notably compressor 2 can be deactivated by the intermediary of solenoid valve 5 or bypass valve at the moment of vehicle acceleration, which cuts off power from the vehicle's motor 1 for the power absorbed by the compressor without playing upon the engagement 3 of the compressor. FIG. 4b illustrates how load shedding works in relation to the cycle seen previously.

So as not to cause loss of pressure in the main circuit when the complementary circuit 33 is enabled, it is advisable to isolate the condenser 7 of the compressor thereby isolating the high-pressure part of the main circuit.

The invention allows for a check valve 6 situated on the first branch circuit 30 downwind of the complementary circuit 33 to hold fluid in the condenser when the complementary circuit 33 is enabled. Thus at the time of the load shedding, the condenser continues to supply refrigerant fluid to the evaporators 8, 9 regulated by the pressure regulators 81, 91.

At the time of deceleration or idling, the main circuit can quickly be reactivated by closing the solenoid valve 5, and the air conditioning operations can be maintained.

Thus as defined by the invention, it is possible to decrease the load on the motor without frequent engagement/disengagement of the compressor 2, but as driven according to a program given by the load shedding valve 5 starting the complementary circuit.

Alternatively, a three-way valve can replace the valve 5 and the check valve 6 without straying from the spirit of the invention.

To limit how much the compressor heats up at the time of its re-locking-up by the complementary circuit, a spiral rotary compressor, or “scroll” compressor, is recommended. In effect, the power absorbed by this type of rotary compressor is inferior to the power absorbed by an equivalent reciprocating motion compressor and, because of its losses from internal friction, this type of compressor heats up very little once sealed. In addition, such a compressor allows for elevated speeds and has better output.

To improve how the device operates, management of the solenoid valve 5 for load shedding is trusted to a computer 10 with the means 15 to detect these phases in a running vehicle.

The computer 10 notably incorporates a means 16 for detecting idling speed in the motor 1, as direct means a sensor 16 on the accelerator, as indirect means such as a sensor to detect the vehicle stopping.

The computer, according to the example, has the ability to measure the external temperature using a temperature sensor 11, the internal temperature using a temperature sensor 12, the calculator with rules to manage engagement 3 and the valve 5 that will be illustrated below in the framework of a method for controlling as defined by the invention of an air conditioning device.

The computer can also manage the temperature of the air flow device 40, 41 pushing cooled air by the evaporators 8, 9 in the passenger compartment.

The operation of the air conditioning device controlled by the computer 10 incorporates the sequences described below.

Test sequences are denoted by diamonds, and actions are denoted by rectangles.

A first sequence shown in FIG. 3a relates to the activation of the air conditioning device.

With the goal of limiting wear and tear on the belt 50 and the engagement 3, there are sequences 202 to enable the complementary circuit 33 simultaneously with the phases of engagement 203 of the compressor. Also it is possible to enable the air conditioning device from the moment the an interior temperature measured by the upper sensor 12 reaches a given value, for example, around 23° C. and to disable it for an lower interior temperature. A test temperature sequence 2000 is allowed for this. Also, and with the goal of not deteriorating the mechanical elements of the device, the method incorporates a sequence 201 to disallow engagement of the compressor when detecting vehicle acceleration, notably in order to not allow the device to start unless the vehicle is idling or at a stop.

It optional, such as for city use, to run the compressor continuously above a threshold of a given interior temperature.

By this principle, once the air conditioning device is running, which corresponds to FIG. 3b [regulation], the invention allows for a reduction of the motor power through controlling of the valve 5, whereby the computer opens the bypass valve at the start of vehicle acceleration to give priority to economy of motor power. In keeping with a condition of running with a closed valve 300, the controlling method therefore incorporates a sequence 301 for test of acceleration, a sequence in which the result triggers an opening sequence 306 or the closing of the solenoid valve 5 that controls the circuit 33.

To avoid overly frequent or untimely openings/closings of the valve 5 during quick accelerations, the sequence 301 of an acceleration test can entail a hysteresis validation phase and start a delaying sequence 308.

For the acceleration test, the computer is capable of detecting an acceleration of the vehicle, for example, by a sensor 15 on the gas pedal 17.

Controlling the device incorporates the detection test 301 followed by sequences 302, 303, 304 to test the temperature given a delay for the delay sequence 308 to allow the discharge operation circuit to be prolonged during a maximum temp, as determined by the temperature, resulting in maintenance sequences on the complementary circuit for a maximum length of time dependent on the measure of the temperature at the vehicle's interior.

For example, the load shedding can be performed in 16 seconds from the moment that acceleration is detected for a low temperature at the threshold of 24° C. for example, corresponding to test 302, which can be reduced to 12 seconds by accelerations for an interior temperature between 24 and 25° C. by test 303, limited to 8 seconds for an interior temperature between 25 and 26° C. by test 304 then deactivated if the interior temperature of the vehicle rises above 26° C., accommodating passenger comfort.

An example of temperature-driven load shedding D and an example of the vehicle's phases of operation are shown in FIGS. 4a and 4b.

FIG. 4a shows a curve N of the motor speed with respect to the time and effect on controlling the valve 5 of FIG. 4b according to the interior temperature T°. As shown, the cycles for opening the valve are limited by a temperature increase.

Other control methods are possible within the scope of the invention. It is possible, for example, to detect deceleration in order to close the valve before the end of the delay, the opening time of the valve being then the smallest value between the delay setting and the acceleration time.

Of course, it is possible to test the sensors, testing loops provided with filtration of the rebound of contactors or of detection thresholds designed to avoid overly frequent openings/closings of the control valve 5.

When the interior temperature falls below the predetermined threshold, this example embodiment is made to stop the air conditioning device. The method shown in FIG. 3c (named “stop”) incorporates a test temperature sequence 310 for this. According to the method for the invention, the computer is programmed to disallow the disengagement of the compressor during deceleration or high speed, so as to avoid excessive surges and/or constraints and to help the vehicle's air conditioning circuit's inertia.

One sequence to disengage the sensor outside of the motor's idling phase incorporates a test 311 of an idling motor when the vehicle is stopped. When the idling motor is affected, the sequence 313 for compressor disengagement happens.

For fine temperature control, the complementary circuit 33 can be controlled by means of a temperature measure on the interior and exterior of the vehicle by controlling the valve 5 through sequences of opening/closing, which is useful on a city course at a stable speed.

The evaporators 8, 9a, 9b distributed throughout the passenger compartment are sized such that, when the bypass valve 5 is set at the time of vehicle acceleration, the evaporators, preceded by a tank/dehydrator 36 create a usable cold reserve.

The device also incorporates a means by which to cut 21 the main circuit 21 upwind of the complementary circuit upon detection of excessive fluid pressure 18 or low fluid pressure 19.

By this method, air conditioning operation is steadily maintained during times of deceleration and idling. Other guidelines for air conditioning devices can be incorporated, and to accommodate various usages, certain items such as ventilators or evaporators can be selectively deactivated.

1. Air conditioning pilot device for vehicles comprising a compressor (2) powered by the vehicle's motor (1) by way of clutch engagement (3), a condenser (7), at least one evaporator (8, 9), and a main circuit for circulating refrigerant fluid between the compressor (2), the condenser (7), and the said evaporator (8, 9), the circuit having a first branch circuit (30) leading fluid from the compressor (2) to the condenser (7), a second branch circuit (31) leading fluid from the condenser (7) to the said evaporator (8, 9), a third branch circuit (32) pulling fluid from the evaporator (8, 9) toward the compressor (2), characterized by having a complementary circuit (33) located between the first branch circuit (30) and the third branch circuit (32), designed to return gas collected by the compressor to the air intake of the compressor and a control device (5, 10) enabling and disabling the complementary circuit.

2. Device as defined by the claim 1, characterized by that it incorporates a check valve (6) located on the first branch circuit (30) downwind of the complementary circuit to hold fluid in the condenser when the complementary circuit (33) is enabled.

3. Device as defined by claims 1 or 2, characterized by that it incorporates a computer (10) to manage the air conditioning device by means (15) of detecting when the vehicle accelerates.

4. Device as defined by the claim 1, characterized by that the computer (10) contains a means (16) by which to detect the motor (1) speed while idling.

5. Device as defined by one of the preceding claims, characterized by that it contains means (11, 12) by which to measure the internal and/or external temperature of the vehicle.

6. Device as defined by one of the preceding claims, characterized by that the compressor is a spiral rotary compressor.

7. Method for controlling a vehicle air conditioning device comprising a compressor (2) powered by the motor (1) of the vehicle (100) by way of clutch engagement (3), a condenser (7), at least one evaporator (8, 9), and a main circuit (30, 31, 32) for circulating refrigerant fluid between the compressor (2), the condenser (7), and the said evaporator (8, 9), a complementary circuit (33), designed to return gas collected by the compressor to the air intake of the compressor, a control device (5, 10) for the complementary circuit, and means (15, 16) of detecting idling, acceleration, and deceleration of the vehicle, characterized by that is incorporates sequences to enable the complementary circuit (33) upon detection of acceleration of the vehicle's motor.

8. Method as defined by the claim 7, characterized by that the air conditioning device incorporates a control device (4, 10) for the engagement and disengagement of the compressor. The method consists of sequences to enable the complementary circuit (33) simultaneously with the engagement of the compressor.

9. Method as defined by the claim 8, characterized by that it incorporates sequences disallowing the engagement of the compressor upon detection of acceleration or high motor speed in the vehicle.

10. Method as defined by one of the claims 7 through 9, characterized by that, the device incorporates a means (11, 12) to measure the temperature of the interior and exterior of the vehicle, the method incorporates sequences for temperature regulation of the vehicle's interior by managing the complementary circuit (33) through a function of measures produced by means of measuring the temperature on the interior and exterior of the vehicle.

11. Method as defined by one of the claims 7 through 10, characterized by that the sequences enabling the complementary circuit (33) upon detection of acceleration of the vehicle's motor are followed by maintenance sequences on the complementary circuit for a maximum duration as determined by a measure of the vehicle's interior temperature.
